(19) United States
(12) Patent Application Publication
(10) Pub. No.: US 2022/0318755 A1
(43) Pub. Date: Oct. 6, 2022

(54) SYSTEMS AND METHODS FOR ADAPTIVE CURATION OF RENDERED DIGITAL ASSETS WITHIN A VIRTUAL WORKSPACE IN A COLLABORATION SYSTEM

(71) Applicant: Haworth, Inc., Holland, MI (US)

(72) Inventor: Rupen Chanda, Austin, TX (US)

(73) Assignee: Haworth, Inc., Holland, MI (US)

(21) Appl. No.: 17/710,902

(22) Filed: Mar. 31, 2022

Related U.S. Application Data
(60) Provisional application No. 63/168,990, filed on Mar. 31, 2021.

(51) Int. Cl. G06Q 10/10; G06F 3/04815

(52) U.S. Cl. CPC G06Q 10/103; G06F 3/04815

(57) ABSTRACT

Systems and methods are provided for implementing adaptive curation of digital assets displayed on a virtual workspace in a collaborative session between network nodes hosted in part by a collaboration system. The system includes logic to retrieve, from a server-side network node, a spatial event map identifying events in the virtual workspace. The virtual workspace comprises locations having virtual coordinates. The events identified by the spatial event map are related to digital assets within the virtual workspace. The system includes logic to identify a local client viewport in the virtual workspace. The system includes logic to render, in the display space on the display, a curated set of digital assets of the plurality of digital assets. The digital assets of the curated set include only digital assets identified as first priority digital assets and exclude other digital assets not identified as being first priority digital assets.

### PRIORITY APPLICATION

This application claims the benefit of U.S. Provisional Patent Application No. 63/168,990, filed on 31 Mar. 2021, which application is incorporated herein by reference.

### FIELD OF INVENTION

The present technology relates to collaboration systems that enable users to actively participate in collaboration sessions from multiple geographic locations.

### BACKGROUND

Collaboration systems are used in a variety of environments to allow users to participate in content review. Users of a collaboration system can join collaboration sessions from locations around the world. A collaboration system can be, for example, integrated into a video conferencing system.

A virtual workspace associated with a collaboration session (as implemented by a collaboration system) can accumulate hundreds, thousands or even hundreds of thousands of digital assets such as documents, spreadsheets, slide decks, images, videos, line drawings, etc. over a period of time as participants collaborate on a project. As the number of digital assets increase, it becomes difficult to navigate the workspace to review the most relevant digital assets for the current collaboration session. The meeting participants can be overwhelmed when presented with large number of digital assets. Precious meeting time can be wasted while navigating through a large number of digital assets to identify digital assets relevant for current meeting.

An opportunity arises to increase efficiency of collaboration meetings by automatically organizing digital assets in a workspace and presenting the most relevant digital assets to meeting participants so that they can efficiently and quickly navigate to the most relevant content for the current meeting.

### SUMMARY

A system and method for operating a collaboration system are provided. The system and method enable adaptive curation of digital assets displayed on a virtual workspace in a collaborative session between network nodes hosted in part by the collaboration system. The collaboration system comprises a client-side network node including a display having a physical display space. The client-side network node can be configured with logic to implement the operations presented herein. The client-side network node can be configured with logic to implement the operation of retrieving a spatial event map from a server-side network node. The spatial event map can identify events in a virtual workspace. The virtual workspace can comprise locations having virtual coordinates. The events identified by the spatial event map are related to digital assets within the virtual workspace. The client-side network node can be configured with logic to implement the operation of identifying a local client viewport in the virtual workspace. The local client viewport can represent a location and dimensions in the virtual workspace including a plurality of digital assets. The client-side network node can be configured with logic to implement the operation of rendering a first curated set of digital assets of the plurality of digital assets in the display space on the display. The first curated set of digital assets are included in the location and dimensions in the virtual workspace represented by the local client viewport. The digital assets of the first curated set include only digital assets identified as first priority digital assets and exclude other digital assets, of the plurality of digital assets, not identified as being first priority digital assets.

In one implementation, the client-side network node is further configured with logic to implement the operation of receiving an input, via the display space, to display digital assets identified as second priority digital assets. The system includes logic to implement the operation of rendering, in response to the input, a second curated set of digital assets of the plurality of digital assets. The digital assets of the second curated set include only digital assets identified as second priority digital assets and exclude other digital assets, of the plurality of digital assets, not identified as being second priority digital assets, such that only digital assets of the first and second curated sets are rendered.

The disclosed systems and methods can be used to implement a third, a fourth, and a fifth curated set of digital assets, respectively including a third, a fourth, and a fifth priority digital assets. The system and method can be used to implement further curated sets of digital assets such as up to a tenth curated set of digital assets including a tenth priority digital assets.

In one implementation, the client-side network node is further configured with logic to implement the operation of rendering, in response to a participant selection of a second zoom level, the first curated set of digital assets which is associated with a first zoom level and the second curated set of digital assets which is associated with the second zoom level. The client-side network node is configured with logic to exclude, from rendering, other digital assets, of the plurality of digital assets, not identified as being the first priority digital assets and not identified as being the second priority digital assets.

Each of the digital assets of the first curated set of digital assets has one or more attributes associated therewith. At least one of the attributes of each of the digital assets of the first curated set of digital assets matches or satisfies criteria included in curation data configured for the collaboration session with the virtual workspace.

In one implementation, the one or more attributes associated with the digital assets can be identified, at least in part, in the spatial event map. The curation data can also be included, at least in part, in the spatial event map.

In one implementation, the words or subject matter identified by one of the attributes of a first priority digital asset, of the first priority digital assets, matches or satisfies a portion of the criteria included in the curation data. The matching or satisfied portion of the criteria of the curation data identifies a frequently uttered phrase captured from a conversation of participants during at least one of the collaboration session and a previous collaboration session.

In one implementation, a region within the virtual workspace identified by one of the attributes of a first priority digital asset, of the first priority digital assets, matches or satisfies a portion of the criteria included in the curation data. The matching or satisfied portion of the criteria of the curation data identifies regions of the virtual workspace that have been accessed a number of times, during at least one of the collaboration session and a previous collaboration session, that is above a threshold.

In one implementation, a region within the virtual workspace identified by one of the attributes of a first priority digital asset, of the first priority digital assets, matches or satisfies a portion of the criteria included in the curation data. The matching or satisfied portion of the criteria of the curation data identifies the top two regions of the virtual workspace for which participants of at least one of the collaboration session and a previous collaboration session have spent the most time, as compared to other regions of the virtual workspace.

In one implementation, words or subject matter identified by one of the attributes of a first priority digital asset, of the first priority digital assets, matches or satisfies a portion of the criteria included in the curation data. The matching or satisfied portion of the criteria of the curation data identifies a title or subject matter indicator of the collaboration session.

In one implementation, words or subject matter identified by one of the attributes of a first priority digital asset, of the first priority digital assets, matches or satisfies a portion of the criteria included in the curation data. The matching or satisfied portion of the criteria of the curation data identifies one or more words in a meeting agenda associated with the collaboration session.

In one implementation, a user name identified by one of the attributes of a first priority digital asset, of the first priority digital assets, matches or satisfies a portion of the criteria included in the curation data. The matching or satisfied portion of the criteria of the curation data identifies a name of a participant of the previous collaboration session.

In one implementation, a department or job title identified by one of the attributes of a first priority digital asset, of the first priority digital assets, matches or satisfies a portion of the criteria included in the curation data. The matching or satisfied portion of the criteria of the curation data identifies a department or job title associated with one or more participants of the collaboration session.

In one implementation, an edit timestamp or an access timestamp identified by one of the attributes of a first priority digital asset, of the first priority digital assets, matches or satisfies a portion of the criteria included in the curation data. The matching or satisfied portion of the criteria of the curation data identifies the top two most recently edited or accessed digital assets.

In one implementation, a score identified by one of the attributes of a first priority digital asset, of the first priority digital assets, meets or exceeds a threshold score identified by the criteria included in the curation data. The score can be calculated in dependence upon a predefined criterion. The threshold score can be set to a predefined value and the predefined value can be adjusted by a user before or during the collaboration session.

In one implementation, words or subject matter identified by one of the attributes associated with a page or portion of a first priority digital asset, of the first priority digital assets, matches a portion of the criteria included in the curation data. The matching portion of the criteria of the curation data identifies a title or subject matter indicator of the collaboration session. The rendering renders the page or the portion of the first priority digital asset.

In one implementation, the client-side network node is further configured with logic to implement the following operations. The client-side network node is configured with logic to implement the operation of rendering an automatically populated graphical user interface that identifies two or more attributes of the digital assets located within the local client viewport. The client-side network node is configured with logic to implement the operation of receiving a selection from a user of a particular attribute, of the two or more attributes identified in the graphical user interface. The client-side network node is configured with logic to implement the operation of rendering digital assets having an attribute that matches the particular attribute selected by the user.

In one implementation, each digital asset of a plurality of digital assets within the virtual workspace has a score associated therewith. The client-side network node is further configured with logic to implement operations including identifying a predetermined number of top scoring digital assets as belonging to the first curated set.

A method for hosting a collaboration session is disclosed. The method includes retrieving, by a client-side network node including a display having a physical display space and from a server-side network node, a spatial event map identifying events in a virtual workspace. The virtual workspace can comprise locations having virtual coordinates. The events identified by the spatial event map are related to digital assets within the virtual workspace. The method includes identifying a local client viewport in the virtual workspace, the local client viewport representing a location and dimensions in the virtual workspace including a plurality of digital assets. The method includes rendering, in the display space on the display, a first curated set of digital assets of the plurality of digital assets that are included in the location and dimensions in the virtual workspace represented by the local client viewport. The digital assets of the first curated set include only digital assets identified as first priority digital assets and exclude other digital assets, of the plurality of digital assets, not identified as being first priority digital assets.

A collaboration system hosting a collaboration session, between client-side network nodes is disclosed. Each client-side network node can include a display having a physical display space and a processor. The collaboration system can comprise a server-side network node configured with logic to implement operations presented herein. The server-side network node is configured with logic to implement the operation of establishing a collaboration session between the client-side network nodes. The server-side network node is configured with logic to implement the operation of receiving an identification of a virtual workspace. Within the collaboration session, the server-side network node is configured with logic to implement the operation of providing, to the client-side network nodes, a spatial event map. The spatial event map identifies events in the virtual workspace. The virtual workspace comprises locations having virtual coordinates. The events identified by the spatial event map can be related to digital assets within the virtual workspace. The spatial event map allows for identification, for the client-side network nodes, of a local client viewport in the virtual workspace. The local client viewport represents a location and dimensions in the virtual workspace including a plurality of digital assets. The spatial event map allows for rendering, in the display space on the display of each of the client-side network nodes, a first curated set of digital assets of the plurality of digital assets that are included in the location and dimensions in the virtual workspace represented by the local client viewport. The digital assets of the first curated set include only digital assets identified as first priority digital assets and exclude other digital assets, of the plurality of digital assets, not identified as being first priority digital assets.

Computer program products which can execute the methods presented above are also described herein (e.g., a non-transitory computer-readable recording medium having a program recorded thereon, wherein, when the program is executed by one or more processors the one or more processors can perform the methods and operations described above).

Other aspects and advantages of the present technology can be seen on review of the drawings, the detailed description, and the claims, which follow.

### BRIEF DESCRIPTION OF THE DRAWINGS

The technology will be described with respect to specific embodiments thereof, and reference will be made to the drawings, which are not drawn to scale, and in which:

FIGS. 1A and 1B illustrate example aspects of a system implementing adaptive curation of a virtual workspace in a collaboration session.

FIGS. 2A, 2B, and 2C include user interface examples of presenting a curated set of digital assets in the display space on a graphical display.

FIGS. 3A, 3B, 3C, 3D, 3E, 3F and 3G present example data structures that can be used to implement adaptive curation of digital assets in a virtual workspace.

FIGS. 4A and 4B include flowcharts presenting process steps performed at the client-side network node for displaying curated set of digital assets.

FIG. 5 is a flowchart presenting process steps performed at the server-side network node for displaying curated set of digital assets in display space on a graphical display.

FIG. 6 includes a flowchart presenting process steps for adaptive curation of workspace including API messages for communication between the server-side network node and the client-side network node.

FIG. 7 is a schematic of a computer system implementing the adaptive workspace navigation technology.

### DETAILED DESCRIPTION

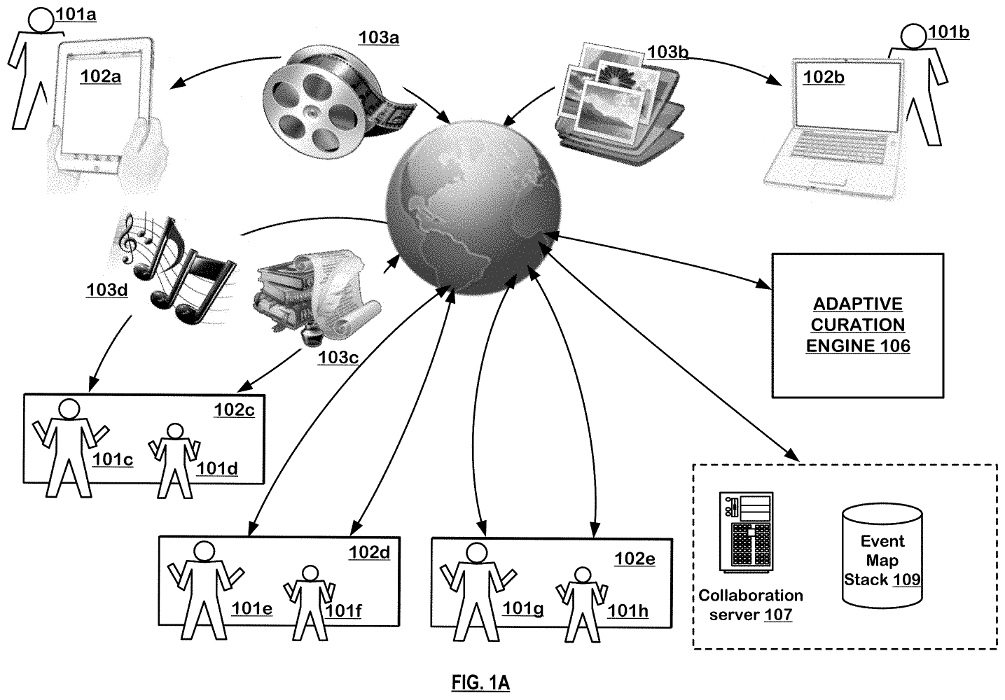

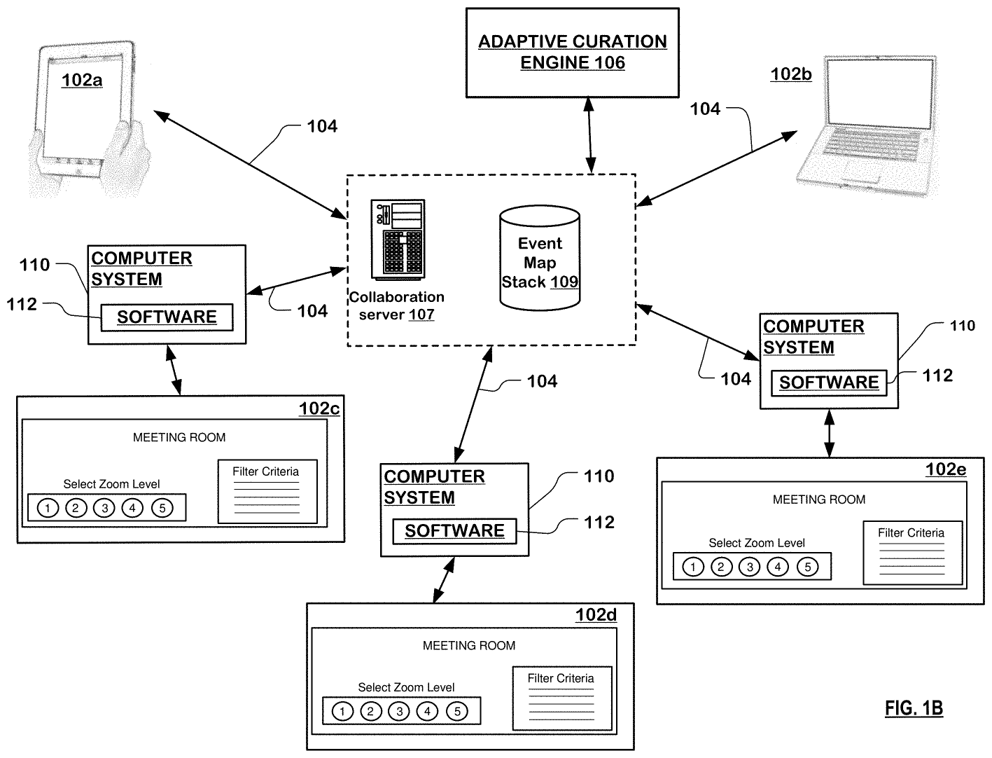

A detailed description of embodiments of the present technology is provided with reference to the FIGS. 1-7.

The following description is presented to enable a person skilled in the art to make and use the technology, and is provided in the context of a particular application and its requirements. Various modifications to the disclosed embodiments will be readily apparent to those skilled in the art, and the general principles defined herein may be applied to other embodiments and applications without departing from the spirit and scope of the present technology. Thus, the present technology is not intended to be limited to the embodiments shown, but is to be accorded the widest scope consistent with the principles and features disclosed herein.

### Environment

We describe a collaboration environment in which users participate in an interactive collaboration session from network nodes located across the world. A user or a participant can join and participate in the collaboration session, using display clients, such as browsers, for large format digital displays, desktop and laptop computers, or mobile computing devices. Collaboration systems can be used in a variety of environments to allow users to contribute and participate in content generation and review. Users of collaboration systems can join collaboration sessions from remote locations around the globe. Participants of a collaboration meeting can share digital assets with other participants in a shared workspace (also referred to as a virtual workspace). The digital assets can be documents such as word processor files, spreadsheets, slide decks, notes, program code, etc. Digital assets can also be graphical objects such as images, videos, line drawings, annotations, etc.

In some cases, participants can work collaboratively on projects for weeks, months or even years. In such projects, many collaboration sessions can be conducted over the course of time. Such collaboration projects can include a large number of digital assets sometimes hundreds, thousands or hundreds of thousands of digital assets that are included in the virtual workspace associated with the collaboration project. Examples of such collaboration projects can include production of an animated movie which can include hundreds of thousands of images that are reviewed by director, producers, actors, graphic designers, etc. during preparation and rehearsals. Other examples can include a military operations command center in which reports and battlefield images from different areas are received and reviewed by the military leadership for decision making. Navigating to the relevant digital asset in virtual workspaces with so many digital assets can be challenging. This can also waste a considerable amount of useful meeting time. In some cases, this can impact the timeliness of the decisions. The technology disclosed automatically presents the most relevant digital assets to meeting participants in a collaboration session. The technology disclosed is related to curating digital assets displayed in a virtual workspace on digital displays, such that the most relevant or most important digital assets are initially presented to the participants according to various criteria, factors, etc.

The technology disclosed can include a processing engine that can receive and process multiple input signals during a collaboration session and assign tags or labels to digital assets. For example, the digital assets can have attributes assigned thereto and the assigned attributes can have values associated therewith. The values can include keywords, phrases, numeric values, etc. The attributes, tags, or labels associated with digital assets can be used to prioritize the digital assets according to their level of relevance or importance with respect to the current collaboration session. The processing engine can be implemented as a software component of a software agent. The processing engine or the software agent can be deployed at a server or implemented in a distributed manner in a client-server architecture.

The technology disclosed includes logic to arrange digital assets in curated sets with respective priority levels (or levels of relevance). At the start of a collaboration session, the technology disclosed presents digital assets to meeting participants in a workspace that are at the highest level of importance (e.g., first priority). This enables the participants to quickly identify a digital assets that are relevant to their discussion for current collaboration session. The technology disclosed includes logic that allows the meeting participants to drill down from the top level of digital assets to digital assets at a next lower level in the hierarchy of digital assets, etc.

The technology disclosed can thus be considered to organize the digital assets in layers of hierarchy. The layers (or levels) at the top include digital assets considered more important for (relevant to) the current collaboration session based on configured curation data. In other words, the technology disclosed enables meeting participants to efficiently navigate to content that is most relevant to their discussion by drilling down to assets in deeper or lower layers of digital assets in the virtual workspace.

FIG. 1A illustrates example aspects of a digital display collaboration environment. In the example, a plurality of users 101a, 101b, 101c, 101d, 101e, 101f, 101g and 101h (collectively 101), may desire to collaborate with each other, including sharing digital assets including, for example, complex images, music, video, documents, and/or other media, all generally designated in FIG. 1A as 103a, 103b, 103c and 103d.

The digital assets can be stored in an external system such as a cloud-based storage system or locally within the collaboration system such as on a resource server or a local storage. Throughout this document the term “collaboration system” can encompasses a video conferencing system that is part of the collaboration system or that is separate from the collaboration system. Resource servers can include logic to maintain security protocols protecting access to the digital assets independent of a workspace. Others digital assets may be available to participants in the workspace without further security protocols.

The users in the illustrated example can use a variety of devices configured as electronic network nodes (e.g., client-side network nodes), in order to collaborate with each other, for example a tablet 102a, a personal computer (PC) 102b, and many large format displays 102c, 102d, 102e. The network nodes can be positioned in locations around the world. The user devices, which can be referred to as (client-side) network nodes, have display clients, such as browsers, controlling displays (e.g., a physical display space) on which a displayable area (e.g., a local client screen space) is allocated for displaying digital assets in a workspace. The displayable area (local client screen space) for a given user may comprise the entire screen of the display (physical display space), a subset of the screen, a window to be displayed on the screen and so on. The display client can set a (client) viewport in the workspace, which identifies an area (e.g., a location and dimensions) in the coordinate system of the workspace, to be rendered in the displayable area (local client screen space).

The display clients at client-side network nodes 102a, 102b, 102c, 102d, 102e are in network communication with a collaboration server 107 configured at a server-side network node. The collaboration server 107 can maintain participant accounts, by which access to one or more workspace data sets can be controlled. A workspace database 109 (also referred to as event stack map or spatial event map) accessible by the collaboration server 107 can store the workspace data sets, which can comprise spatial event maps. The attributes of the client-side network nodes 102a, 102b, 102c, 102d and 102e and curation data related to a virtual workspace and/or collaboration session can be stored by the collaboration server 107 within, for example the workspace data sets and spatial event maps, and can be communicated from the collaboration server 107 to the client-side network nodes 102a, 102b, 102c, 102d and 102e and vice-versa. The collaboration server 107 can also establish video conference sessions between the client-side network nodes 102a, 102b, 102c, 102d and 102e for simultaneous video conferencing and virtual workspace collaboration.

The collaboration server 107 can include or communicate with an adaptive curation engine 106. Additionally, the client-side network nodes 102a, 102b, 102c, 102d and 102e can include the adaptive curation engine 106. The adaptive curation engine 106 includes logic to determine a curated set of digital assets of the plurality of digital assets that are included in the location and dimensions in the virtual workspace. In one implementation, the adaptive curation engine 106 is implemented partially on the server-side and partially on the client-side in a distributed manner. It is understood that other implementations of the adaptive curation engine 106 are possible i.e., implementing the adaptive curation engine 106 completely on the server-side or implementing the adaptive curation engine 106 completely on the client-side.

The adaptive curation engine 106 includes logic to generate or identify a plurality of curated sets of digital assets. For example, a first curated set of digital assets can be identified to include only digital assets identified as first priority digital assets and can exclude other digital assets, of the plurality of digital assets, not identified as being first priority digital assets. Similarly, the adaptive curation engine 106 includes logic generate or identify a second curated set of digital assets that includes only digital assets identified as second priority digital assets and excludes other digital assets, of the plurality of digital assets, not identified as being second priority digital assets. The technology disclosed can generate or identify up to thousands of curated sets of digital assets according to the determined priority or relevance of the digital assets. Therefore, the technology disclosed helps participants of the meeting to efficiently focus on only a specific number of curated sets of digital assets at a time. The participants of the collaboration session can selectively drill down the hierarchy of digital assets by selecting a curated set of digital assets at a particular priority ranking (or zoom level) in the hierarchy. The more important (or relevant) digital assets are included in the higher level (such as first, second, third, etc.) priority levels.

The prioritization of digital assets can be based on attributes associated with respective digital assets. The adaptive curation engine matches one or more attributes of the digital assets to curation data configured for the virtual workspace of the collaboration session to assign digital assets to different sets of curated digital assets. In one implementation, the one or more attributes associated with the digital assets are identified, at least in part, in the spatial event map. In one implementation, the curation data is included, at least in part, in the spatial event map. The curation data can be received, at least in part, as an input by/from one or more client-side network nodes. The input can be received via the digital display associated with the client-side network node or via other input sources such as a voice signal (or voice command) provided to the client-side network node.

The technology disclosed can use a variety of matching criteria of the curation data to prioritize digital assets and assign the digital assets to a plurality of curated sets of digital assets according to their respective prioritization.

The (matching) criteria of the curation data can identify a frequently uttered phrase or a plurality of phrases captured from a conversation of participants (during a previous collaboration session, during a current collaboration session or at any other time). Based on whether the criteria of the curation data matches (or satisfies) one or more attributes of digital assets, the digital assets can be assigned to a corresponding curated set. For example, if a particular digital asset has two or more attributes that match the criteria of the curation data, then that particular digital asset can be assigned to a first curated set of digital assets (e.g., the most relevant set of digital assets). Further, if another digital asset has only one attribute that matches the criteria of the curation data, then the other digital asset can be assigned to a second (e.g., less relevant) curated set of digital assets. Moreover, if a digital asset does not have any attribute that matches the criteria of the curation data, then the digital asset can be excluded from any curated set of digital assets or it can be assigned to a curated set that identifies the least relevant digital assets. As a result, digital assets that are aligned with previous conversations of collaboration participants can be (initially) rendered during a current collaboration session.

The criteria of the curation data can identify regions of the virtual workspace that have been accessed a number of times (during some time constraint or other type of constraint) that is above a threshold. For example, the criteria can specify that a particular region of the virtual workspace should be identified as being the most relevant if that region has been accessed a certain X number of times during a specific time frame or during a certain number of previous collaboration sessions. Similarly, the criteria can specify that a particular region of the virtual workspace should be identified as being the second most relevant if that region has been accessed a certain Y number of times, etc. If one or more attributes of a digital asset indicate that the digital asset is located in a region that has been accessed the certain X number of times (or more), then the digital asset can be assigned to the first curated set of digital assets. Similarly, if one or more attributes of a digital asset indicate that the digital asset is located in a region that has been accessed the certain Y number of times (or more), then the digital asset can be assigned to the second curated set of digital assets, etc. Additionally, the criteria of the curation data can identify the top X number of regions for which participants of the collaboration session and/or a previous collaboration session have spent the most time, as compared to other regions of the virtual workspace. The attributes of the digital assets can be used to determine which digital assets match the criteria and then the digital assets can be appropriately assigned to curation sets. For example, the digital assets located in the top two regions can be assigned to the first curated set, the digital assets located the top 3^{rd} to 5^{th} regions can be assigned to the second curates set, etc. As a result, digital assets that are located in regions of the virtual workspace that are more popular during previous collaboration sessions can be (initially) rendered in the current collaboration session.

Another example of criteria of the curation data can include identifying a title or subject matter indicator of the collaboration session. If the title or subject matter of the collaboration session matches attributes of digital assets, then those matching digital assets can be included in the first curated set. If the title or subject matter of the collaboration session more loosely matches attributes of digital assets, then those loosely matching digital assets can be included in the second curated set, etc. As a result, digital assets that are related to the title or subject matter of the collaboration session will be (initially) rendered during the collaboration session.

An example of criteria of the curation data can include identifying one or more words in a meeting agenda associated with the collaboration session. If a certain number of words (or keywords) of the agenda match attributes of digital assets, then those matching digital assets can be included in the first curated set. If a fewer number of words (or keywords) than the certain number of words (or keywords) match attributes of digital assets, then those matching digital assets can be included in the second curated set, etc. As a result, digital assets that are related to the agenda of the collaboration session will be (initially) rendered during the collaboration session.

An example of criteria of the curation data can include identifying a name of a participant of the current collaboration session involving the virtual workspace. If an attribute of a digital asset identifies a name of a user that matches the participant of the current collaboration session, then that digital asset can be included in the first curated set of digital assets. This concept can be carried out using time data or data from previous collaboration sessions, with respect to a user that has interacted with a particular digital asset. For example, the attributes of the digital assets can associate a digital asset with a user who viewed/edited/manipulated/etc. that digital asset and can indicate how long ago or how many previous collaboration sessions ago that user viewed/edited/manipulated/etc. the digital asset. That digital asset can be assigned to a particular curated set based on criteria set forth in the curated data, such that the criteria assigns the digital asset to the curated set according to how long ago and/or how many times the user (that matches the participant of the current collaboration session) previously viewed/edited/manipulated/etc. the digital asset. As a result, digital assets, for which the various participants of the current collaboration session have had frequent or recent interaction with, will be part of a curated set that is (initially) rendered during the collaboration session.

Another example of criteria of the curation data can include identifying a department or job title associated with one or more participants of the collaboration session. If an attribute of a digital asset matches the department or job title of a participant of the current collaboration session, then the digital asset can be assigned to a particular curated set. Departments and/or job titles can also be ranked, such that digital assets associated with higher ranking positions or departments can be assigned to a first curated set and digital assets associated with lower ranking positions or departments can be assigned to a second curated set. As a result, digital assets that are related to departments and/or job titles of participants of a current collaboration can be (initially) rendered during the collaboration session.

An example of criteria of the curation data can include, a top most recently edited and/or accessed digital asset. If an edit timestamp and/or an access timestamp of a digital asset qualifies it as a top most recently edited and/or accessed digital asset, then the digital asset can be assigned to a particular curated set. For example, the top two most recently edited and/or accessed digital assets, of all of the digital assets can be assigned to the first curated set, the top 3 to 5 most recently edited and/or accessed digital assets, of all of the digital assets can be assigned to the second curated set, etc. As a result, more popular digital assets, where popularity can be based on time/history and frequency, can be assigned to higher ranking curated sets.

Additionally, an example of criteria of the curation data can include using threshold scores, wherein digital assets have scores associated therewith and if a score of a particular digital asset exceeds a particular threshold score, then that particular digital asset can be assigned to a curation set associated with that particular threshold score. The threshold scores can be set and adjusted by users and/or by the collaboration system and the scores associated with the digital assets can be set and adjusted by users and/or by the collaboration system using any type of criteria described herein or elsewhere. For example, the threshold scores can be manually adjusted by a participant to shrink or grow the various curated sets of digital assets.

Furthermore, the top X scoring digital assets can be assigned to the first curated set, then the next top Y scoring digital assets can be assigned to the second curated set, etc.

Another example of criteria of the curation data can include using a title or subject matter indicator of the collaboration section to match up with words or subject matter identified by one of the attributes associated with a page or portion of a digital asset. Then the particular page or portion of the digital asset can be rendered accordingly. As a result, particularly relevant pages or portions of digital assets will be rendered during the collaboration session so that the participants not only receive an identification of the relevant digital assets, but also receive an identification of the particular page(s) and/or portion(s) of the digital asset that are the most relevant to the title or subject matter (or some other criteria) of the collaboration session.

Other examples of curation data to prioritize digital assets can include such as “meeting relevance”, “participant relevance”, “recently viewed” etc.

As used herein, a network node is an active electronic device that is attached to a network, and is capable of sending, receiving, or forwarding information over a communications channel. Examples of electronic devices which can be deployed as network nodes, include all varieties of computers, display walls, workstations, laptop and desktop computers, handheld computers and smart phones.

As used herein, the term “database” does not necessarily imply any unity of structure. For example, two or more separate databases, when considered together, still constitute a “database” as that term is used herein.

The operation of a network node to implement adaptive curation of digital assets in a collaboration session (such as a video conference) with other network nodes can be hosted in part by a collaboration system. This can include establishing the video conference between the other network nodes. The network node and each of the other network nodes can include a display having a physical display space, a user input device, a processor and a communication port.

We now describe some elements of the collaboration system before presenting further details of the technology disclosed.

### Workspace

A collaboration session can include access to a data set having a coordinate system establishing a virtual space, termed the “workspace” or “virtual workspace”, in which digital assets are assigned coordinates or locations in the virtual space. The workspace can be characterized by a multi-dimensional and in some cases two-dimensional Cartesian plane with essentially unlimited extent in one or more dimensions for example, in such a way that new content can be added to the space, that content can be arranged and rearranged in the space, that a user can navigate from one part of the space to another. The workspace can also be referred to as a “container” in the sense it is a data structure that can contain other data structures or links to other objects or data structures.

### Viewport

Display clients at participant client network nodes in the collaboration session can display a portion, or mapped area, of the workspace, where locations on the display are mapped to locations in the workspace. A mapped area, also known as a viewport within the workspace is rendered on a physical screen space (e.g., a local client screen space). Because the entire workspace is addressable in for example Cartesian coordinates, any portion of the workspace that a user may be viewing itself has a location, width, and height in Cartesian space. The concept of a portion of a workspace can be referred to as a “viewport” or “client viewport”. The coordinates of the viewport are mapped to the coordinates of the screen space (e.g., the local client screen space) on the display client which can apply appropriate zoom levels based on the relative size of the viewport and the size of the screen space. The coordinates of the viewport can be changed which can change the objects contained within the viewport, and the change would be rendered on the screen space of the display client. Details of the workspace and the viewport are presented in our U.S. Pat. No. 11,126,325 (Atty. Docket No. HAWT 1025-1), entitled, “Virtual Workspace Including Shared Viewport Markers in a Collaboration System,” filed 23 Oct. 2017, which is incorporated by reference as if fully set forth herein.

### Spatial Event Map

Using a virtually unlimited workspace introduces a need to track how people and devices interact with the workspace over time. This can be achieved using a “spatial event map”. The spatial event map contains information needed to define objects and events in the workspace. It is useful to consider the technology from the point of view of space, events, maps of events in the space, and access to the space by multiple users, including multiple simultaneous users. The spatial event map contains information to define objects and events in a workspace. The spatial event map can include events comprising data specifying virtual coordinates of location within the workspace at which an interaction with the workspace is detected, data specifying a type of interaction, a digital asset associated with the interaction, and a time of the interaction. The one or more attributes associated with the digital assets can be identified, at least in part, in the spatial event map. The curation data can be included, at least in part, in the spatial event map. The zoom level data can also be included in the spatial event map, identifying the zoom level or the priority level at which the digital assets are displayed on the display space in the digital display.

The spatial event map contains and/or identifies content in the workspace for a given collaboration session. The spatial event map defines arrangement of digital assets (or objects) on the workspace. The spatial event map contains information needed to define digital assets, their locations, and events in the workspace. The collaboration system maps portions of workspace to a digital display e.g., a touch enabled display using the spatial event map. Further details of the workspace and the spatial event map are presented in U.S. Pat. No. 10,304,037, entitled, “Collaboration System Including a Spatial Event Map,” filed Nov. 26, 2013, which is incorporated by reference as if fully set forth herein.

### Events

Interactions with the workspace are handled as events. People, via tangible user interface devices, and systems can interact with the workspace. Events have data that can define or point to a target digital asset to be displayed on a physical display, and an action as creation, modification, movement within the workspace and deletion of a target digital asset, and metadata associated with them. Metadata can include information such as originator, date, time, location in the workspace, event type, security information, and other metadata.

Tracking events in a workspace enables the system to not only present the events in a workspace in its current state, but to also share the events with multiple users on multiple displays, to share relevant external information that may pertain to the content, and understand how the spatial data evolves over time. Also, the spatial event map can have a reasonable size in terms of the amount of data needed, while also defining an unbounded workspace.

FIG. 1B illustrates the same environment as in FIG. 1A. The application running at the collaboration server 107 can be hosted using Web server software such as Apache or nginx. It can be hosted for example on virtual machines running operating systems such as LINUX. The architecture can involve systems of many computers, each running server applications, as is typical for large-scale cloud-based services. The collaboration server 107 can include or can be in communication with a server and authorization engine that includes communication modules which can be configured for various types of communication channels, including more than one channel for each client (e.g., network node) in a collaboration session. For example, using near-real-time updates across the network, client software 112 can communicate with the communication modules via using a message-based channel, based for example on the Web Socket protocol. For file uploads as well as receiving initial large volume workspace data, the client software 112 can communicate with a server communication module of, for example, the collaboration server 107, via HTTP. The server and authorization engine can run front-end programs written for example in JavaScript and HTML using Node.js, support authentication/authorization based for example on OAuth, and support coordination among multiple distributed clients (e.g., network nodes). The front-end programs can be written using other programming languages and web-application frameworks such as in JavaScript served by Ruby-on-Rails. The server communication module can include a message-based communication protocol stack, such as a Web Socket application, that performs the functions of recording user actions in workspace data (e.g., a spatial event map), and relaying user actions to other clients (e.g., network nodes) as applicable. Parts of the collaboration system can run on a node.JS platform for example, or on other server technologies designed to handle high-load socket applications.

The collaboration server 107 can include or can be in communication with database 109. As mentioned above, the event map stack database 109 includes a workspace data set (e.g., a spatial event map) including events in the collaboration workspace and digital assets, such as digital assets, distributed at virtual coordinates in the virtual workspace. Examples of digital assets are presented above, such as images, music, video, documents, application windows and/or other media. Other types of digital assets, such as digital assets can also exist on the workspace such as annotations, comments, and text entered by the users. The database can also store attributes of digital assets and curation data that is matched to the values of attributes to select curated sets of digital assets. In one implementation, the attributes can be assigned weights which can indicate which attributes are more important than others. In such implementation, a combination of attribute values can be used to assign digital assets to curated sets of digital assets. When using combination of attributes, equal weight can be assigned to different attributes of digital assets, or a weighted combination of attributes can be used to assign digital assets to curated sets of digital assets.

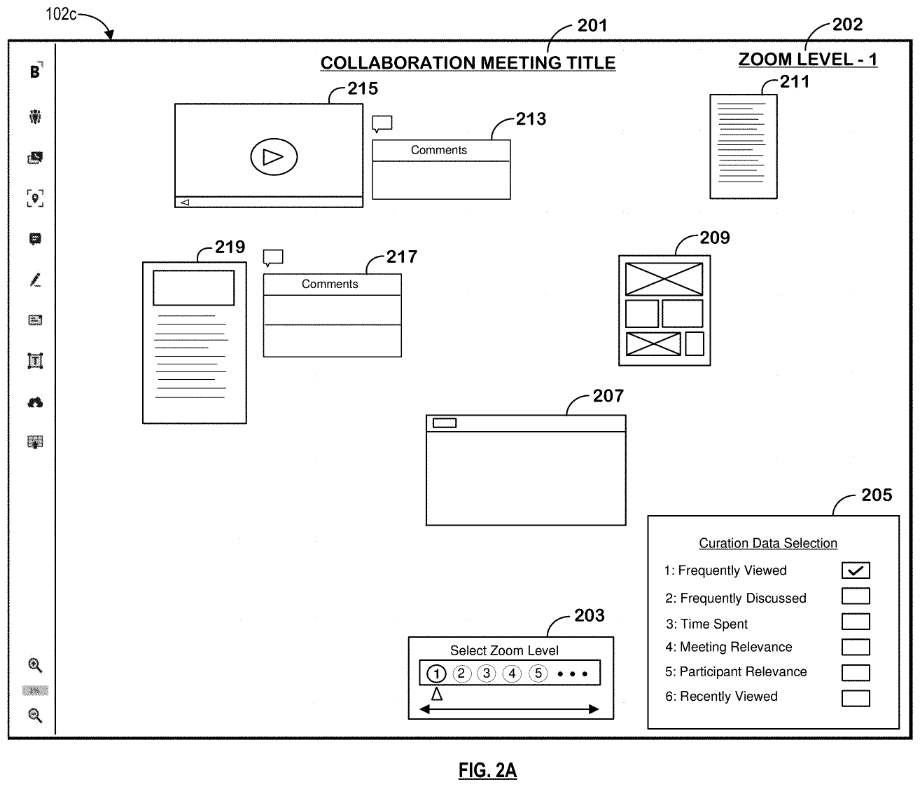

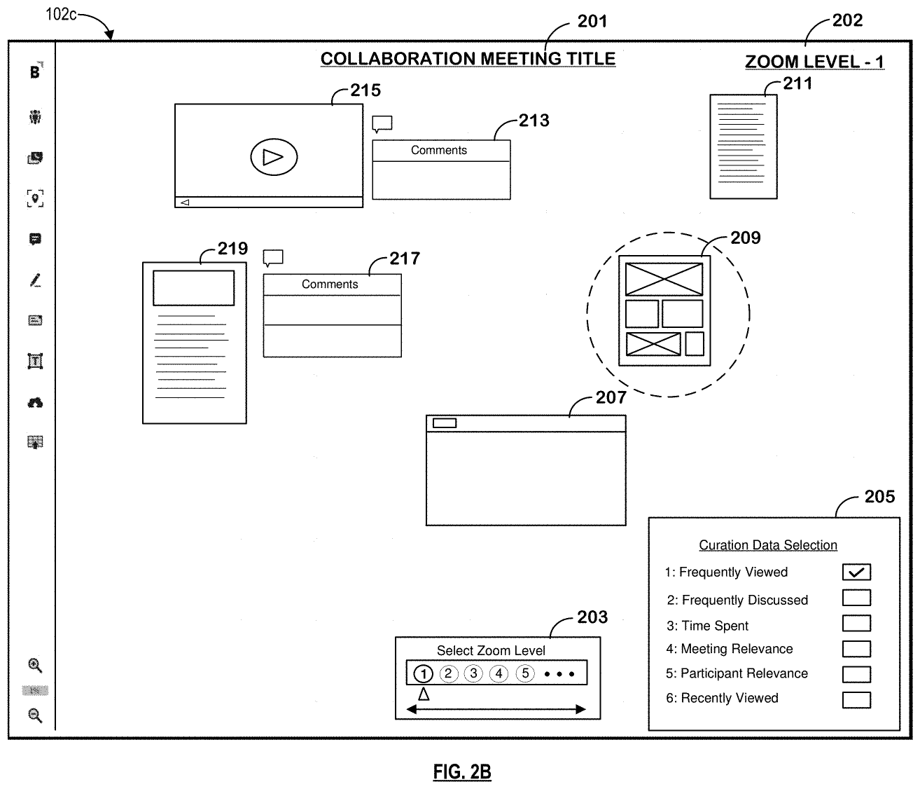

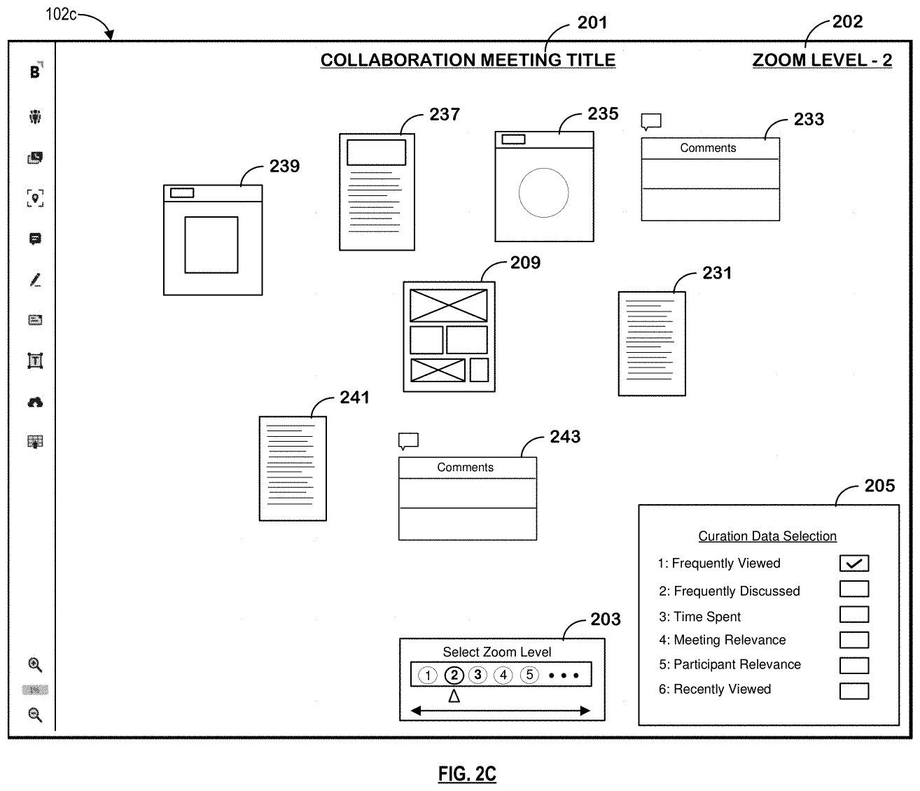

We now present various examples of user interface elements that can be used to provide functionality related to starting a collaboration session (or collaboration meeting), adding one or more workspaces to the collaboration session, including creating and implementing adaptive curation of digital assets during the collaboration session. The systems described above with reference to FIGS. 1A and 1B can be implemented to establish and conduct the various types of collaboration sessions described below. As illustrated in FIG. 1B, and as discussed in further detailed below with reference to FIGS. 2A, 2B and 2C, the client-side network nodes 102c, 102d and 102e provide a user interface that allows the user (participant of the collaboration session) to select/change zoom levels that results in the rendering of different curated sets of digital assets and also provide a user interface that allows the user to adjust filtering criteria generated based on the attributes of the digital assets.

### Curating Digital Assets in a Collaboration Session

FIGS. 2A to 2C present user interface examples of a display space on a digital display associated with the client-side network node 102c. A title 201 of the meeting can be displayed at top of the display space and a zoom level of the current display space 202 can also be displayed on the display space. A “zoom level-1” corresponds with first priority digital assets. The first priority digital assets can include the most important digital assets for a collaboration session or the most relevant digital assets as determined by matching of the curation data with attribute values associated with the digital assets. The example in FIG. 2A shows seven digital assets labeled as 207, 209, 211, 213, 215, 217, and 219 at zoom level-1. The digital assets displayed at zoom level-1 can be considered as the digital assets included in the first curated set of digital assets. These digital assets are identified as first priority digital assets which can indicate that these digital assets are the most important digital assets for the current collaboration session using the curation data selected for prioritization of digital assets.

FIG. 2A also shows a “curation data selection” user interface element 205 and a “select zoom level” user interface element 203. The curation data selection user interface element lists some examples of curation data that can be used to prioritize digital assets in the curated set of digital assets. One or more user curation data can be selected using the curation data selection user interface element 205 to prioritize the digital assets for the collaboration session. Some example of curation data listed in the FIG. 2A include frequently viewed, frequently discussed, time spent, meeting relevance, participant relevance and recently viewed, etc. Additional curation data can be included, the above listed curation data is an example. FIG. 2A shows that “frequently viewed” criterion is selected for prioritization of digital assets by using the checkbox. The curation data selection user interface element 205 can be populated by analyzing the various attributes of the digital assets within the virtual workspace, such that the participant is provided with a visualization of some or all of the attributes of the various digital assets and such that the user can select or de-select various attributes related to the digital assets and essentially filter out the undesired attributes (or the digital assets associated with the undesired attributes).

The “select zoom level” user interface element 203 can be used by the meeting participants to drill down from the first priority digital assets to review digital assets that are not included in the first priority digital assets. The current zoom level is set at “level 1.” therefore, the first priority (or the top level) digital assets are displayed on the display space. During the discussion in collaboration session, the meeting participants may want to review more digital assets which are not included in the first priority digital assets. The user interface element 203 can be used to display a zoomed in view of the digital assets at deeper levels of hierarchy by selecting zoom level-2, zoom level-3, and so on. The zoom level can be adjusted in many other ways as wells, such as by holding down certain keys on a keyboard and scrolling a mouse, by using two or three-finger pinching gestures on a touch screen or a non-touch screen gesture environment or by using voice commands.

FIG. 2B shows that a digital asset 209 is selected by one of the participants of the collaboration for drilling down to view further digital assets at zoom level-2. The selected digital asset 209 is shown in a circle of broken line. The participant can then select zoom level “2” using the user interface element 203. Zoom level can be adjusted without a participant selecting one of the digital assets. However, by selecting one of the digital assets (e.g., digital asset 209), the subsequent zooming operation can be centered around the selected digital asset and/or it can be performed to use criteria for the zooming operation that is based on attributes and/or additional criteria related to the selected digital asset.

FIG. 2C shows the digital assets in the zoom level-2 displayed on the display space of the graphical display 102c. The select zoom level user interface element 203 shows that the current zoom level is “2”. The current zoom level is also displayed on the top-right corner of the display 102c indicated by a label 202. Note that the digital asset 209 which was selected by the meeting participant is displayed in the middle of the display space. In addition, the example in FIG. 2C shows digital assets labeled as 231, 233, 235, 237, 239, 241, and 243 displayed on the display space in the digital display 102c. The digital assets 231 to 243 listed above are the second priority digital assets which are included the second curated set of digital assets. The curation data selected for the current example is “frequently viewed”. This means that the digital assets in the second priority digital assets are less frequently viewed as compared to the digital assets in the first priority digital assets. For example, the digital assets in the first priority digital assets are viewed at least ten times in the last two collaboration sessions. Or the digital assets in the first priority digital assets are viewed at least ten times in one week. Other threshold values such as greater than 10 views or less than 10 views can be used for the first priority digital assets. Similarly, other threshold values can be set for second priority digital assets. For example, in one instance, the digital assets in second priority digital assets are viewed at least five times in the last two collaboration sessions. Or the digital assets in the second priority digital assets are viewed at least five times in one week.

FIG. 2C shows one implementation of the technology disclosed in which one digital asset 209 which is a first priority digital asset included in the first curated set of digital assets is displayed in zoom level-2. The rest of the digital assets displayed in zoom level-2 are second priority digital assets included in the second curated set of digital assets. This can be a result of a participant of the collaboration session selecting digital asset 209 prior to selecting zoom level-2. In another implementation, a particular digital asset (such as the digital asset 209) is not selected prior to changing the zoom level. In such implementation, a participant can change the zoom level using the user interface element 203 without selecting a digital asset and the digital assets of the prior zoom level may not be displayed on the display space. For example, in such implementation, the digital asset 209 is not displayed on the display screen in FIG. 2C. In yet another implementation, when a participant selects zoom level-2 when the current display of the digital assets is at zoom level-1, the digital assets at zoom level-1 are also displayed along with the digital assets at zoom level-2 after the zoom level is updated on the display space. In the following sections we describe some scoring techniques that can be used to prioritize digital assets.

### Scoring the Events

The participants in a collaboration session can perform a variety of interactive tasks in the workspace. For example, a user can touch a document in the workspace to open that document, annotate on the document that is open in the workspace, or share the document with other users, etc. A task performed by a user can result in a number of interaction events generated by the system. Additionally, the technology disclosed enables multiple users to interact with the collaboration workspace at the same time. The technology disclosed can assign scores to interaction events. Some types of events can be assigned a higher level of importance (reflected in higher score) than others. The technology disclosed can group interaction events in categories. The technology disclosed can calculate a collaboration score for a group of events in a category by accumulating scores in all events in that category. The events and categories can be weighted. In another embodiment, the technology disclosed can calculate collaboration score for digital assets by accumulating scores for all events related to that asset. The collaboration score can be calculated for a participant and for a collaboration session by accumulating scores of respective events. Details of calculation of collaboration score (also referred to as creative collaboration index or CCI) are presented in our U.S. application Ser. No. 16/591,415 (Atty. Docket No. HAWT 1029-2), entitled, “Systems and Methods for Determining a Creative Collaboration Index,” filed Oct. 2, 2019, which is included in this application and fully set forth herein.

### Scoring the Digital Assets

The technology disclosed can also score events related to a digital asset based on the time spent by the participants on an asset. The team members can work on a project outside a meeting or a collaboration session. This can be referred to as offline interaction. Individual team members can create, edit, comment, annotate, or collate digital assets in the workspace. During a collaboration session, the team members can work as a group and perform similar tasks during a collaboration session. During the meetings or collaboration sessions, the meeting participants can spend more time on some of the digital assets. For example, if participants spend a significant amount of time discussing a slide deck, the technology disclosed can increase the score for the events related to the slide deck to reflect the relevance of the slide deck to meeting participants. The technology disclosed can also assign high score to particular portions of digital assets if more time is spent by the participants on those portions. For example, if participants of the meeting spend most of the time on one or two slides of the slide deck, the technology disclosed can assign higher score to those slides in the slide deck. The scores assigned to the digital assets or portions of the digital assets can be used in labeling the digital assets with tags representing layers of hierarchy. The digital assets at the highest level (or top layer) are then displayed in a next collaboration session at the start of the meeting.

### Capturing and Combining Signals to Prioritize Digital Assets

The technology disclosed can capture audio signals, such as conversation between meeting participants during a collaboration session. The technology disclosed can then link the audio signals with interaction events or activities performed by participants on the digital assets in the workspace occurring at the same time. For example, if participants of the meeting spend a considerable amount of time in discussion while a particular slide in a slide deck is displayed on the digital display, then the system assigns a high score to that slide. If meeting participants switch between two slides in the slide deck during their conversation and spend a considerable amount of conversation time while one of the two slides is displayed on the digital display, then the system assigns high scores to both slides in the slide deck. Similarly, the system can assign high scores to other assets that are opened on the digital display when the conversation between the participants is occurring. The system can also use other inputs to determine the content with which the participants are interacting during the meeting such as commenting, annotating, editing, sharing, moving, etc. The system can perform natural language processing (NLP) to determine keywords in audio signals of the conversation and match the keywords to digital assets or portions of digital assets. The system can assign high scores to digital assets or portions of digital assets that are either displayed on the digital for a longer period of duration or they are referred to during the conversation of the participants.

The system can correlate the voice content collected from conversations between meeting participants and activities on the digital assets at different time intervals (such as every 10 seconds, every 30 seconds, every minute, every 5 minutes, every 10 minutes). The system can also analyze how team members are contributing outside of meetings, the number of team members who are contributing by performing activities on which digital assets, and how much time they are spending on digital assets outside the meeting. Therefore, in addition to the activities performed by meeting participants in the meeting, the system can perform analysis of voice content of conversations in time intervals such as transcript analysis using natural language processing or other transcript analysis techniques. In that time duration, the system can identify the location of participants' activities in the workspace and the digital assets with which the participants are interacting. The system can include this information in calculation of scores for digital assets for the information evolution model, identifying the most important digital assets for a next collaboration meeting. The technology disclosed can perform the above scoring on groups or collections of digital assets.

The technology disclosed can analyze audio signals of conversations between participants (also referred to as voice context) with activities in the spatial event map. The system can assign scores to digital assets by current activity level identified by the events in the spatial event map. The system can also assign score to events based on categories of events as presented in our U.S. application Ser. No. 16/591,415 (Atty. Docket No. HAWT 1029-2), entitled, “Systems and Methods for Determining a Creative Collaboration Index,” referenced above and included in this application and fully set forth herein. The system can also include other scoring schemes to score the digital assets or assign labels to digital assets. The labels assigned to digital assets can be used when matching curation data to the attributes associated with digital assets. The digital assets with top scores or in a highest range of scores can be assigned to first curated set of digital assets identified as first priority digital assets. The digital assets with lower score are assigned to second curated set of digital assets identified as second priority digital assets and so on. Therefore, the technology disclosed can organize the digital assets in a hierarchical organization of digital assets. The system can include up to 10 or more layers of hierarchy to help meeting participants quickly curate content for collaboration meeting.

### Additional Scoring Criteria

The system can apply additional criteria when calculating scores for digital assets. For example, a security model vector can be applied which includes information about which users have access to which document. The security model can have different roles assigned to users. User can have access to authorized digital assets or portions of digital assets. For example, when a meeting owner logs in to the system, the system can display digital assets in the first curated set of digital assets to which the owner has access. Therefore, when the meeting starts, the meeting owner can see the see the most important documents for the current meeting displayed on the digital display. The system can also display portions of the document that are of high value for current meeting. For example, a document may have ten pages but only two pages that are most important ones for the current meeting are displayed. The meeting owner or any other participant can interact with the workspace to see the next level of detail by zooming in. The zoom level-2 may display eight more pages of the document which were not shown at zoom level-1.

The system may also display annotations on the document pages in the lower zoom level which were not displayed in the higher zoom level (such as zoom level-1). Then the user can drill down further, and the system can show more digital assets in the workspace such as images, videos, comments related to the document which were not shown at the higher zoom levels. Note that the scoring for the digital assets can include a combination of multiple input signals during a period of time such as activities being performed on the document, voice context determined from the audio signals and any other criteria such as security model.

### Workspace Data Structures

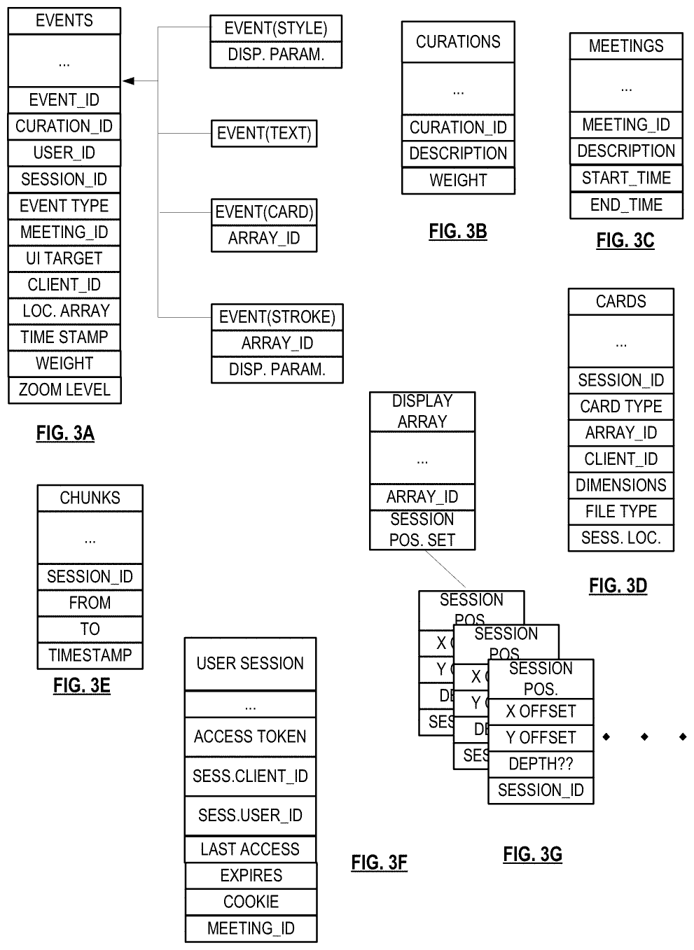

FIGS. 3A-3G represent data structures which can be part of workspace data maintained by a database at the collaboration server 107.

In FIG. 3A, an events data structure is illustrated. An event is an interaction with the workspace that can result in a change in workspace data. An event can include an event identifier, and a meeting identifier. Other attributes that can be stored in the events data structure can include a user identifier, a timestamp, a session identifier, an event type parameter, the client identifier, and an array of locations in the workspace, which can include one or more locations for the corresponding event. It is desirable for example that the timestamp have resolution on the order of milliseconds or even finer resolution, in order to minimize the possibility of race conditions for competing events affecting a single object. Also, the event data structure can include a UI target, which identifies an object (such as a digital asset) in the workspace data to which a stroke on a touchscreen at a client display is linked. Events can include a curation data identifier (or curation_id) to indicate the curation data used to prioritize digital assets. Events data can also include a zoom level data field to identify current zoom level at which the digital assets are displayed on the display space. Events can include style events, which indicate the display parameters of a stroke for example. The events can include a text type event, which indicates entry, modification, or movement in the workspace of a text object. The events can include a card type event, which indicates the creation, modification, or movement in the workspace of a card type object. The events can include a stroke type event which identifies a location array for the stroke, and display parameters for the stroke, such as colors and line widths for example.

Events can be classified as persistent, history events and as ephemeral events. Processing of the events for addition to workspace data, and sharing among users can be dependent on the classification of the event. This classification can be inherent in the event type parameter, or an additional flag or field can be used in the event data structure to indicate the classification.

A spatial event map can include a log of events having entries for history events, where each entry comprises a structure, such as illustrated in FIG. 3A. The server-side network node includes logic to receive messages carrying ephemeral and history events from client-side network nodes, and to send the ephemeral events to other client-side network nodes without adding corresponding entries in the log, and to send history events to the other client-side network nodes while adding corresponding entries to the log.

FIG. 3B presents a curations data structure. The curations data structure can include a curation identifier, a description of the curation data and a weight of the curation data. A higher weight can be assigned to some curation data than others. When multiple curation data are selected to prioritize digital assets, the curation data can be combined using their respective weights. For example, if “frequently viewed” curation data has a weight of “2” and “meeting relevance” curation data has a weight of “1”, then during prioritization, the “frequently viewed” criterion will be given twice as much weight as “meeting relevance” criterion. The curations data structure can also include other fields such as a “type” field which can identify a category or type of curation data. Examples of curation data types can include content-related curation data, participant-related curation data, time-related curation data, recency-related curation data, etc. It is understood that other types of curation data and curation data types are possible and can be added as further use cases of the technology disclosed are implemented.

FIG. 3C presents a meetings data structure. The meetings data structure includes a meeting identifier, a description data, a start time and an end time of the meeting. The meeting data structure can include other fields such as a meeting agenda, number of participants, a department identifier, a virtual workspace identifier, a timestamp etc. The description data can include keywords or topics discussed in the meeting. This can be used to prioritize meetings based on keywords or topics related curation data. The meeting agenda data can include details of the topics discussed in the meeting which can also be used to prioritize meetings. A plurality of meetings can be associated with a virtual workspace. The meeting data 3C is linked to the events data 3A via a foreign key such as meeting identifier (or meeting_id) in the events data structure 3A. The events can be used to identify digital assets. Over a period of time as meetings are conducted, the meeting data accumulates and can be used to prioritize the digital assets by matching with curation data.

The system can also include a card data structure 3D. The card data structure can provide a cache of attributes that identify current state information for a digital asset in the workspace data, including a session identifier, a card type identifier, an array identifier, the client identifier, dimensions of the cards, type of file associated with the card, and a session location within the workspace.

The system can include a chunks data structure 3E which consolidates a number of events and objects into a cacheable set called a chunk. The data structure includes a session ID, and identifier of the events included in the chunk, and a timestamp at which the chunk was created.

The system can include a user session data structure 3F for links to a user participating in a session in a chosen workspace. This data structure can include a session access token, the client identifier for the session display client, the user identifier linked to the display client, a parameter indicating the last time that a user accessed a session, and expiration time and a cookie for carrying various information about the session. This information can, for example, maintain a current location within the workspace for a user, which can be used each time that a user logs in to determine the workspace data to display at a display client to which the login is associated. A user session can also be linked to a meeting. One or more than one user can participate in a meeting. A user session data structure can identify the meeting in which a user participated in during a given collaboration session. Linking a user session to a meeting enables the technology disclosed to determine the identification of the users and the number of users who participated in the meeting.

The system can include a display array data structure 3G which can be used in association with large-format displays that are implemented by federated displays, each having a display client. The display clients in such federated displays cooperate to act as a single display. The workspace data can maintain the display array data structure which identifies the array of displays by an array ID, and identifies the session position of each display. Each session position can include an x-offset and a y-offset within the area of the federated displays, a session identifier, and a depth. We now present process steps for implementing adaptive curation of virtual workspace using curated data sets of digital assets.

### Process Flowcharts

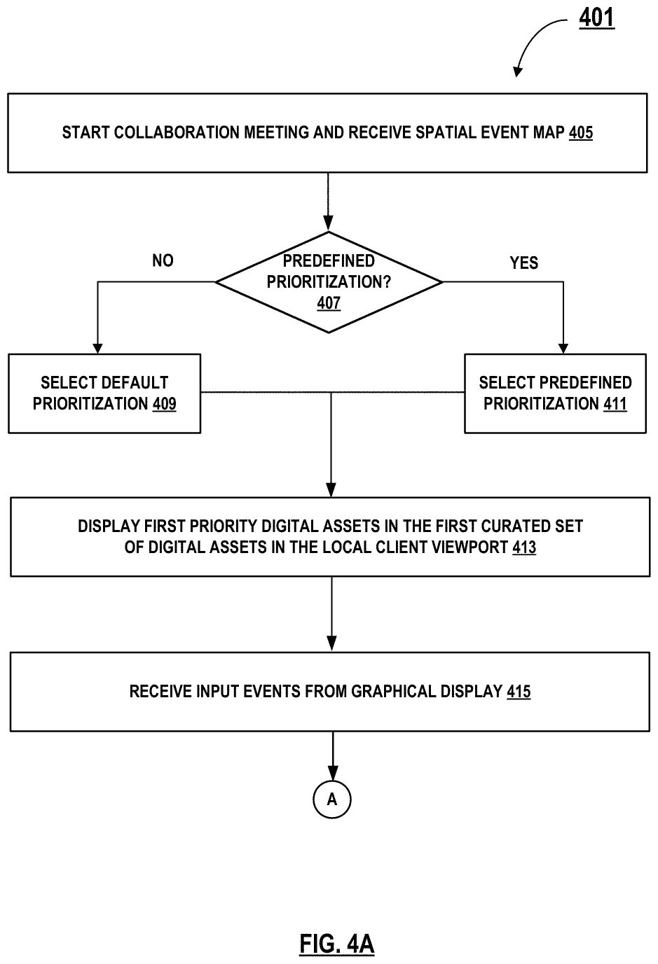

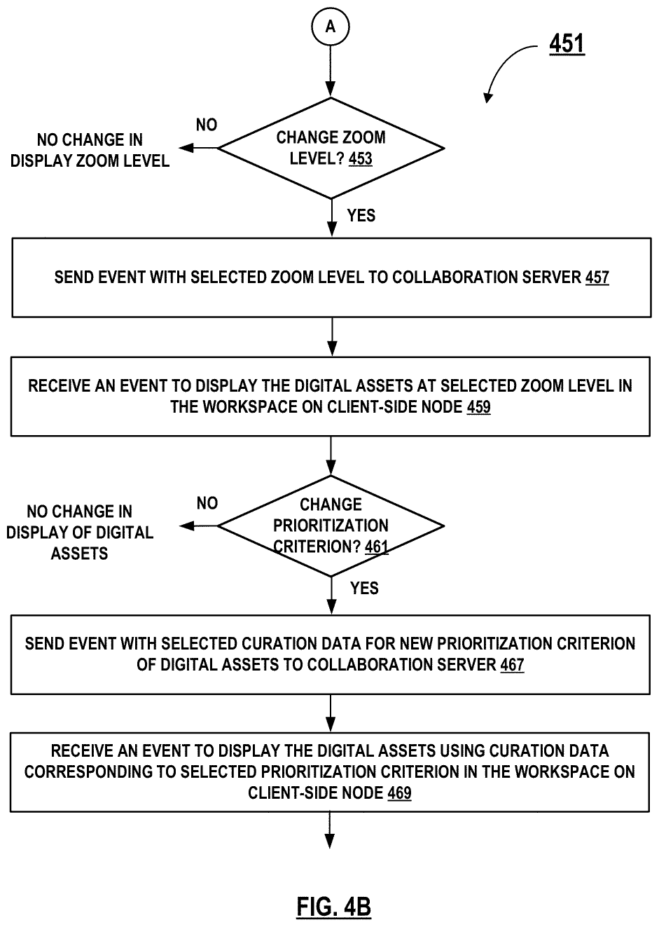

FIGS. 4A to 6 present process flowcharts for conducting a collaboration session including adaptive curation of virtual workspaces containing digital assets. The flowcharts illustrate logic executed by clients (network nodes), a server (collaboration server) or both. The logic can be implemented using processors programmed using computer programs stored in memory accessible to the computer systems and executable by the processors, by dedicated logic hardware, including field programmable integrated circuits, and by combinations of dedicated logic hardware and computer programs. As with all flowcharts herein, it will be appreciated that many of the steps can be combined, performed in parallel or performed in a different sequence without affecting the functions achieved. In some cases, as the reader will appreciate, a re-arrangement of steps will achieve the same results only if certain other changes are made as well. In other cases, as the reader will appreciate, a re-arrangement of steps will achieve the same results only if certain conditions are satisfied. Furthermore, it will be appreciated that the flow charts herein show only steps that are pertinent to an understanding of the technology, and it will be understood that numerous additional steps for accomplishing other functions can be performed before, after and between those shown.

### Client-Side Process for Prioritizing Digital Assets Using Curation Data

FIGS. 4A and 4B present client-side process for displaying curated sets of digital assets that are prioritized according to the curation data configured for the virtual workspace.

FIG. 4A is a flowchart 401 presenting high-level client-side process for starting a collaboration session and displaying first priority digital assets in the display space on a digital display. The process starts at operation 405. The system includes logic to retrieve a spatial event map from a server-side network node. The spatial event map identifies events in a virtual workspace. The virtual workspace can comprise locations having virtual coordinates. The events identified by the spatial event map are related to digital assets within the virtual workspace.

The system includes logic to detect whether a predefined prioritization criterion is included in the spatial event map using curation data retrieved from the server (operation 407). If no predefined criterion is defined, a default prioritization criterion can be used to prioritize digital assets (operation 409). Any one of the prioritization criteria as presented above such as “frequently viewed”, “frequently discussed”, “time spent”, “meeting relevance”, “participant relevance”, “recently viewed” etc. can be used to prioritize the digital assets. It is understood that one or more additional default criteria can be defined for prioritization of digital assets. If a predefined prioritization criterion is included in the spatial event map using curation data retrieved from the server, then the system can use that to prioritize digital assets (operation 411). A predefined prioritization can be one of the prioritization criteria listed above or a combination of two or more criteria listed above. A weighted combination of the predefined criteria can also be used to prioritize the digital assets.

The system includes logic to render a first curated set of digital assets in the display space on the display (operation 413). The first curated set of digital assets of the plurality of digital assets are included in the location and dimensions in the virtual workspace represented by the local client viewport. The system includes logic to receive input events from graphical display at operation 415. The process continues in a process flowchart presented in FIG. 4B.

FIG. 4B includes a flowchart 451 presenting process to change zoom level and prioritization criterion for displaying digital assets on a display space in the digital display. If the system receives input via the user interface on the graphical display requesting a change in zoom level (operation 453), the process continues at operation 457, otherwise, no change in zoom level is made. The system includes logic to send an event to the collaboration server including the selected zoom level (operation 457). The system then receives an event from the collaboration server to display the digital assets at the selected zoom level in the virtual workspace on the client-side node (operation 459).

If the system receives an input event via the user interface on the graphical display to change the prioritization criteria (operation 461), the process continues at operation 467, otherwise no change is performed in the display of digital assets on the display space. The system includes logic to send an event with the selected curation data for new prioritization criterion to collaboration server (operation 467). The system includes logic to receive an event to display digital assets using updated curation data corresponding to new prioritization criterion in the workspace on the client-side node (operation 469). The event can include updated curated set of digital assets for display on the display space in the digital display.

### Server-Side Process for Prioritizing Digital Assets Using Curated Data

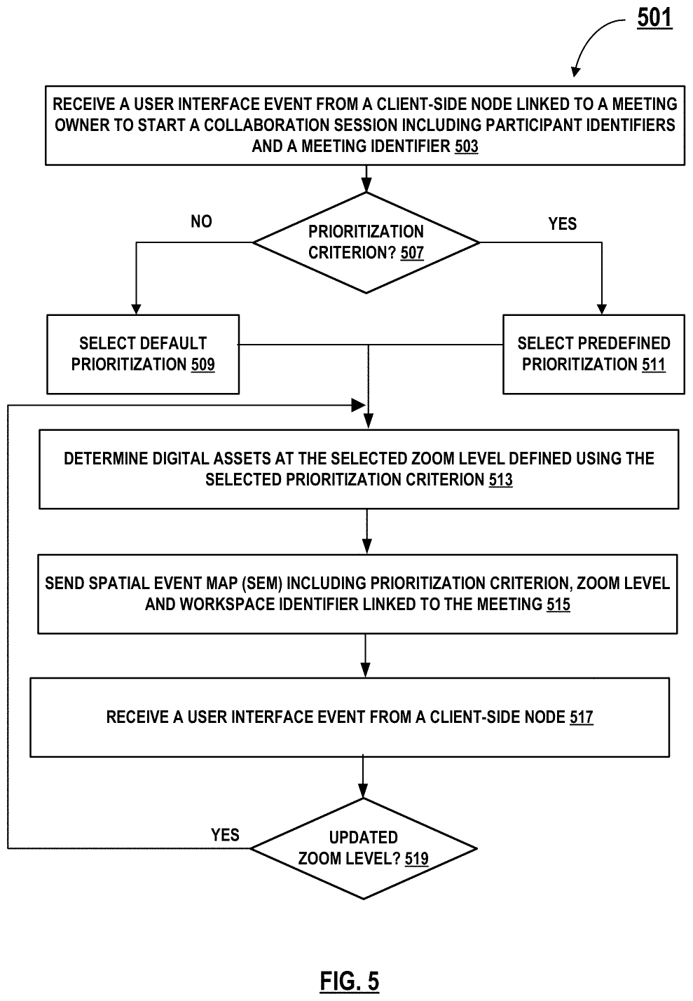

FIG. 5 presents a process flowchart 501 presenting server-side process for prioritizing digital assets using curation data configured for the virtual workspace. The server includes logic to receive a user interface event from a client-side node linked to a meeting owner or a meeting participant to start a collaboration session including participant identifiers and a meeting identifier (operation 503). If a prioritization criterion is predefined using curation data (operation 507) than the system can use that for prioritization of digital assets (operation 511) otherwise select default prioritization criterion (operation 509).

The server includes logic to use prioritization criterion to determine digital assets at the selected zoom level (operation 513). The server can then send the spatial event map including the curation data identifying prioritization criterion, zoom level and workspace identifier linked to the meeting (operation 515). The server can receive user interface events from the client-side node (operation 517). If the event received from the client-side node includes an updated zoom level (operation 519), the process continues at operation 513.

The server can follow the process to display digital assets with first and second level authorizations as described in the U.S. patent application Ser. No. 17/200,731, entitled, “User Experience Container Level Identity Federation and Content Security” filed on Mar. 12, 2021 (Attorney Docket No. 1032-2).

### Client-Side Process for Adaptive Curation of Digital Assets Including Receiving a Spatial Event Map

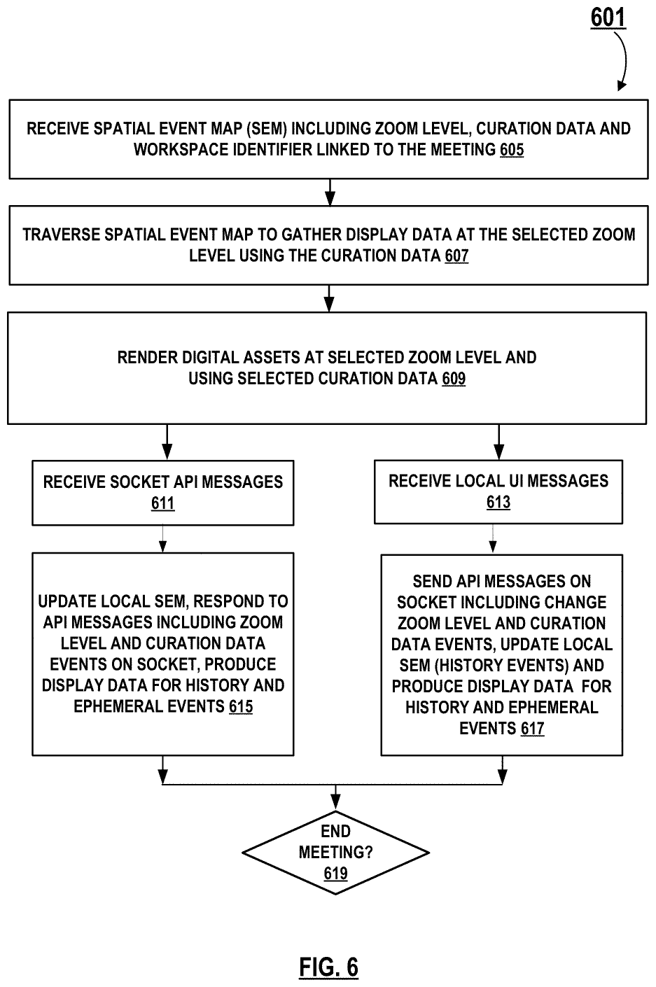

FIG. 6 presents a process flowchart 601 including client-side process steps to start a collaboration session, receive a spatial event map by a client-side network node of the collaboration session, and render curated sets of digital assets on the display space. The order illustrated in the simplified flow diagram is provided for the purposes of illustration, and can be modified as suits a particular implementation. Many of the steps for example, can be executed in parallel.

The process starts at operation 605. The collaboration server provides an identifier of, or identifiers of parts of, the spatial event map (or SEM) which can be used by the client to retrieve the spatial event map from the collaboration server. The client retrieves the spatial event map, or at least portions of it, from the collaboration server using the identifier or identifiers provided at which the client-side node receives a spatial event map including the curation data for prioritization of digital assets. The spatial event map identifier can also be used to identify the workspace (or canvas) attached to or associated with the collaboration session. The virtual workspace contains the digital assets for the participants of the collaboration session. Further, the data from the server can also include zoom level at which the digital assets will be displayed on the display space in the graphical display.

For example, the client can request all history for a given workspace to which it has been granted access as follows:

curl http://localhost:4545/<sessionId>/history

The server will respond with all chunks (each its own section of time):

[“/<sessionId>/history/<startTime>/<endTime>?b=1”]
[“/<sessionId>/history/<startTime>/<endTime>?b=1”]

For each chunk, the client will request the events:

Curl http: //localhost:4545/<sessionId>/history/<startTime>/
<endTime>?b=<cache-buster>

Each responded chunk is an array of events and is cacheable by the client:

```
[
  [
    4,
      ″sx″,
        ″4.4″,
        [537, 650, 536, 649, 536, 648, ...],
      {
            “size″: 10,
            ″color″: [0, 0, 0, 1],
            ″brush″: 1
          },
        1347644106241,
        ″cardFling″
      ]
]
```

The individual messages might include information like position on screen, color, width of stroke, time created etc.

The client then determines a viewport in the workspace, using for example a server provided focus point, and display boundaries for the local display. The client-side node (network node) includes logic to traverse spatial event map (SEM) to gather display data (operation 607). The local copy of the spatial event map is traversed to gather display data for spatial event map entries that map to the displayable area for the local display. At this step the system traverses spatial event map to gather display data digital assets for spatial map events. In some embodiments, the client may gather additional data in support of rendering a display for spatial event map entries within a culling boundary defining a region larger than the displayable area for the local display, in order to prepare for supporting predicted user interactions such as zoom level and pan within the workspace. The display data can include virtual workspace attached to collaboration session. This data can also include coordinates indicating the boundary of the virtual workspace.

The process continues at operation 609 at which the client-side node displays the digital assets, at the selected zoom level and using the selected curation data, on the display of the client-side node. The client processor executes a process using spatial event map events and display data to render parts of the spatial event map that fall within the viewport. The system includes logic to display digital assets. In one implementation, specific parts of the digital assets such as particular pages in a document or particular slides in a slide deck are displayed when the attributes of the digital assets match the curation data.

The client-side network node can receive socket API messages (operation 611). The client-side node can receive local user interface messages (operation 613). Also, the client-side node receives socket API messages from the collaboration server. In response to local user interface messages, the client-side node can classify inputs as history events and ephemeral events, send API messages on the socket to the collaboration server for both history events and ephemeral events as specified by the API, the API message can include change zoom level requests, change curation data to prioritize the digital assets using other criteria, update the cached portions of the spatial event map with history events, and produce display data for both history events and ephemeral events (operation 617). In response to the socket API messages, the client-side node can update the cached portion of the spatial event map with history events identified by the server-side network node, responds to API messages on the socket as specified by the API, the API message can include change zoom level and/or change curation data events, and produce display data for both history events and ephemeral events about which it is notified by the socket messages (operation 615).

The client-side node can detect receipt of a message from the collaboration server to end the collaboration session (operation 619). The client-side node can then end the collaboration session and send updates to the spatial event map to the collaboration server.

### Computer System

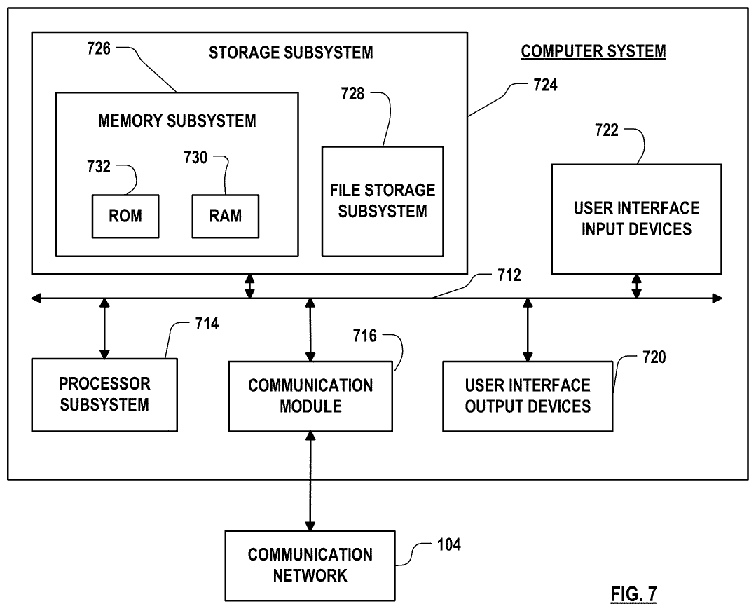

FIG. 7 is a simplified block diagram of a computer system, or network node, which can be used to implement the client-side functions (e.g. computer system 110) or the server-side functions (e.g. server 107) in a distributed collaboration system. A computer system typically includes a processor subsystem 714 which communicates with a number of peripheral devices via bus subsystem 712. These peripheral devices may include a storage subsystem 724, comprising a memory subsystem 726 and a file storage subsystem 728, user interface input devices 722, user interface output devices 720, and a communication module 716. The input and output devices allow user interaction with the computer system. Communication module 716 provides physical and communication protocol support for interfaces to outside networks, including an interface to communication network 104, and is coupled via communication network 104 to corresponding communication modules in other computer systems. Communication network 104 may comprise many interconnected computer systems and communication links. These communication links may be wireline links, optical links, wireless links, or any other mechanisms for communication of information, but typically it is an IP-based communication network, at least at its extremities. While in one embodiment, communication network 104 is the Internet, in other embodiments, communication network 104 may be any suitable computer network.

The physical hardware component of network interfaces are sometimes referred to as network interface cards (NICs), although they need not be in the form of cards: for instance they could be in the form of integrated circuits (ICs) and connectors fitted directly onto a motherboard, or in the form of macrocells fabricated on a single integrated circuit chip with other components of the computer system.

User interface input devices 722 may include a keyboard, pointing devices such as a mouse, trackball, touchpad, or graphics tablet, a scanner, a touch screen incorporated into the display (including the touch sensitive portions of large format digital display such as 102c), audio input devices such as voice recognition systems, microphones, and other types of tangible input devices. In general, use of the term “input device” is intended to include all possible types of devices and ways to input information into the computer system or onto computer network 104.

User interface output devices 720 may include a display subsystem, a printer, a fax machine, or non-visual displays such as audio output devices. The display subsystem may include a cathode ray tube (CRT), a flat panel device such as a liquid crystal display (LCD), a projection device, or some other mechanism for creating a visible image. In the embodiment of FIG. 1B, it includes the display functions of large format digital display such as 102c. The display subsystem may also provide non-visual display such as via audio output devices. In general, use of the term “output device” is intended to include all possible types of devices and ways to output information from the computer system to the user or to another machine or computer system.

Storage subsystem 724 stores the basic programming and data constructs that provide the functionality of certain embodiments of the present invention.

The storage subsystem 724 when used for implementation of server-side network-nodes, comprises a product including a non-transitory computer readable medium storing a machine readable data structure including a spatial event map which locates events in a workspace, wherein the spatial event map includes a log of events, entries in the log having a location of a graphical target of the event in the workspace and a time. Also, the storage subsystem 724 comprises a product including executable instructions for performing the procedures described herein associated with the server-side network node.

The storage subsystem 724 when used for implementation of client side network-nodes, comprises a product including a non-transitory computer readable medium storing a machine readable data structure including a spatial event map in the form of a cached copy as explained below, which locates events in a workspace, wherein the spatial event map includes a log of events, entries in the log having a location of a graphical target of the event in the workspace and a time. Also, the storage subsystem 724 comprises a product including executable instructions for performing the procedures described herein associated with the client-side network node.

For example, the various modules implementing the functionality of certain embodiments of the invention may be stored in storage subsystem 724. These software modules are generally executed by processor subsystem 714.

Memory subsystem 726 typically includes a number of memories including a main random access memory (RAM) 730 for storage of instructions and data during program execution and a read only memory (ROM) 732 in which fixed instructions are stored. File storage subsystem 728 provides persistent storage for program and data files, and may include a hard disk drive, a floppy disk drive along with associated removable media, a CD ROM drive, an optical drive, or removable media cartridges. The databases and modules implementing the functionality of certain embodiments of the invention may have been provided on a computer readable medium such as one or more CD-ROMs, and may be stored by file storage subsystem 728. The host memory 726 contains, among other things, computer instructions which, when executed by the processor subsystem 714, cause the computer system to operate or perform functions as described herein. As used herein, processes and software that are said to run in or on “the host” or “the computer,” execute on the processor subsystem 714 in response to computer instructions and data in the host memory subsystem 726 including any other local or remote storage for such instructions and data.

Bus subsystem 712 provides a mechanism for letting the various components and subsystems of a computer system communicate with each other as intended. Although bus subsystem 712 is shown schematically as a single bus, alternative embodiments of the bus subsystem may use multiple busses.

The computer system itself can be of varying types including a personal computer, a portable computer, a workstation, a computer terminal, a network computer, a television, a mainframe, a server farm, or any other data processing system or user device. In one embodiment, a computer system includes several computer systems, each controlling one of the tiles that make up the large format display such as 102c. Due to the ever-changing nature of computers and networks, the description of computer system 110 depicted in FIG. 7 is intended only as a specific example for purposes of illustrating the preferred embodiments of the present invention. Many other configurations of the computer system are possible having more or less components than the computer system depicted in FIG. 7. The same components and variations can also make up each of the other devices 102 in the collaboration environment of FIG. 1, as well as the collaboration server 107 and database 109.

Certain information about the drawing regions active on the digital display 102c are stored in a database accessible to the computer system 110 of the display client. The database can take on many forms in different embodiments, including but not limited to a MongoDB database, an XML database, a relational database, or an object oriented database.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present technology may consist of any such feature or combination of features. In view of the foregoing description, it will be evident to a person skilled in the art that various modifications may be made within the scope of the technology.

The foregoing description of preferred embodiments of the present technology has been provided for the purposes of illustration and description. It is not intended to be exhaustive or to limit the technology to the precise forms disclosed. Obviously, many modifications and variations will be apparent to practitioners skilled in this art. For example, though the displays described herein are of large format, small format displays can also be arranged to use multiple drawing regions, though multiple drawing regions are more useful for displays that are at least as large as 12 feet in width. In particular, and without limitation, any and all variations described, suggested by the Background section of this patent application or by the material incorporated by reference are specifically incorporated by reference into the description herein of embodiments of the technology. In addition, any and all variations described, suggested or incorporated by reference herein with respect to any one embodiment are also to be considered taught with respect to all other embodiments. The embodiments described herein were chosen and described in order to best explain the principles of the technology and its practical application, thereby enabling others skilled in the art to understand the technology for various embodiments and with various modifications as are suited to the particular use contemplated. It is intended that the scope of the technology be defined by the following claims and their equivalents.

What is claimed is:

1. A collaboration system hosting a collaboration session, the collaboration system comprising:
a client-side network node including a display having a physical display space, the client-side network node being configured with logic to implement operations including:
retrieving, from a server-side network node, a spatial event map identifying events in a virtual workspace, the virtual workspace comprising locations having virtual coordinates, the events identified by the spatial event map being related to digital assets within the virtual workspace;
identifying a local client viewport in the virtual workspace, the local client viewport representing a location and dimensions in the virtual workspace including a plurality of digital assets; and
rendering, in the display space on the display, a first curated set of digital assets of the plurality of digital assets that are included in the location and dimensions in the virtual workspace represented by the local client viewport, the digital assets of the first curated set including only digital assets identified as first priority digital assets and excluding other digital assets, of the plurality of digital assets, not identified as being first priority digital assets.

2. The system of claim 1, wherein the client-side network node is further configured with logic to implement operations including:
receiving an input, via the display space, to display digital assets identified as second priority digital assets; and
rendering, in response to the input, a second curated set of digital assets of the plurality of digital assets, the digital assets of the second curated set including only digital assets identified as second priority digital assets and excluding other digital assets, of the plurality of digital assets, not identified as being second priority digital assets, such that only digital assets of the first and second curated sets are rendered.

3. The system of claim 2, wherein the client-side network node is further configured with logic to implement operations including:
rendering, in response to a participant selection of a second zoom level, the first curated set of digital assets which is associated with a first zoom level and the second curated set of digital assets which is associated with the second zoom level and excluding, from rendering, other digital assets, of the plurality of digital assets, not identified as being the first priority digital assets and not identified as being the second priority digital assets.

4. The system of claim 1,
wherein each of the digital assets of the first curated set of digital assets has one or more attributes associated therewith, and
wherein at least one of the attributes of each of the digital assets of the first curated set of digital assets matches or satisfies criteria included in curation data configured for the collaboration session with the virtual workspace.

5. The system of claim 4, wherein the one or more attributes associated with the digital assets are identified, at least in part, in the spatial event map.

6. The system of claim 4, wherein the curation data is included, at least in part, in the spatial event map.

7. The system of claim 4,
wherein words or subject matter identified by one of the attributes of a first priority digital asset, of the first priority digital assets, matches or satisfies a portion of the criteria included in the curation data, and
wherein the matching or satisfied portion of the criteria of the curation data identifies a frequently uttered phrase captured from a conversation of participants during at least one of the collaboration session and a previous collaboration session.

8. The system of claim 4,
wherein a region within the virtual workspace identified by one of the attributes of a first priority digital asset, of the first priority digital assets, matches or satisfies a portion of the criteria included in the curation data, and
wherein the matching or satisfied portion of the criteria of the curation data identifies regions of the virtual workspace that have been accessed a number of times, during at least one of the collaboration session and a previous collaboration session, that is above a threshold.

9. The system of claim 4,
wherein a region within the virtual workspace identified by one of the attributes of a first priority digital asset, of the first priority digital assets, matches or satisfies a portion of the criteria included in the curation data, and
wherein the matching or satisfied portion of the criteria of the curation data identifies top two regions of the virtual workspace for which participants of at least one of the collaboration session and a previous collaboration session have spent the most time, as compared to other regions of the virtual workspace.

10. The system of claim 4,
wherein words or subject matter identified by one of the attributes of a first priority digital asset, of the first priority digital assets, matches or satisfies a portion of the criteria included in the curation data, and
wherein the matching or satisfied portion of the criteria of the curation data identifies a title or subject matter indicator of the collaboration session.

11. The system of claim 4,
wherein words or subject matter identified by one of the attributes of a first priority digital asset, of the first priority digital assets, matches or satisfies a portion of the criteria included in the curation data, and
wherein the matching or satisfied portion of the criteria of the curation data identifies one or more words in a meeting agenda associated with the collaboration session.

12. The system of claim 4,
wherein a user name identified by one of the attributes of a first priority digital asset, of the first priority digital assets, matches or satisfies a portion of the criteria included in the curation data, and
wherein the matching or satisfied portion of the criteria of the curation data identifies a name of a participant of the collaboration session.

13. The system of claim 4,
wherein a department or job title identified by one of the attributes of a first priority digital asset, of the first priority digital assets, matches or satisfies a portion of the criteria included in the curation data, and
wherein the matching or satisfied portion of the criteria of the curation data identifies a department or job title associated with one or more participants of the collaboration session.

14. The system of claim 4,
wherein an edit timestamp or an access timestamp identified by one of the attributes of a first priority digital asset, of the first priority digital assets, matches or satisfies a portion of the criteria included in the curation data, and
wherein the matching or satisfied portion of the criteria of the curation data identifies top two most recently edited or accessed digital assets.

15. The system of claim 4,
wherein a score identified by one of the attributes of a first priority digital asset, of the first priority digital assets, meets or exceeds a threshold score identified by the criteria included in the curation data.

16. The system of claim 15, wherein the score is calculated in dependence upon a predefined criterion.

17. The system of claim 15, wherein the threshold score is set to a predefined value and the predefined value can be adjusted by a user before or during the collaboration session.

18. The system of claim 4,
wherein words or subject matter identified by one of the attributes associated with a page or portion of a first priority digital asset, of the first priority digital assets, matches a portion of the criteria included in the curation data,
wherein the matching portion of the criteria of the curation data identifies a title or subject matter indicator of the collaboration session, and
wherein the rendering renders the page or the portion of the first priority digital asset.

19. The system of claim 1, wherein the client-side network node is further configured with logic to implement operations including:
rendering an automatically populated graphical user interface that identifies two or more attributes of the digital assets located within the local client viewport;
receiving a selection from a user of a particular attribute, of the two or more attributes identified in the graphical user interface; and
rendering digital assets having an attribute that matches the particular attribute selected by the user.

20. The system of claim 1,
wherein each digital asset of a plurality of digital assets within the virtual workspace has a score associated therewith, and
wherein the client-side network node is further configured with logic to implement operations including identifying a predetermined number of top scoring digital assets as belonging to the first curated set.

21. A method for hosting a collaboration session, the method including:
retrieving, by a client-side network node including a display having a physical display space and from a server-side network node, a spatial event map identifying events in a virtual workspace, the virtual workspace comprising locations having virtual coordinates, the events identified by the spatial event map being related to digital assets within the virtual workspace;
identifying a local client viewport in the virtual workspace, the local client viewport representing a location and dimensions in the virtual workspace including a plurality of digital assets; and
rendering, in the display space on the display, a first curated set of digital assets of the plurality of digital assets that are included in the location and dimensions in the virtual workspace represented by the local client viewport, the digital assets of the first curated set including only digital assets identified as first priority digital assets and excluding other digital assets, of the plurality of digital assets, not identified as being first priority digital assets.

22. A collaboration system hosting a collaboration session, between client-side network nodes, each including a display having a physical display space and a processor, the collaboration system comprising:
a server-side network node configured with logic to implement operations including:
establishing a collaboration session between the client-side network nodes;
receiving an identification of a virtual workspace; and
within the collaboration session:
providing, to the client-side network nodes, a spatial event map identifying events in the virtual workspace, the virtual workspace comprising locations having virtual coordinates, the events identified by the spatial event map being related to digital assets within the virtual workspace;
wherein the spatial event map allows for identification, for the client-side network nodes, of a local client viewport in the virtual workspace, the local client viewport representing a location and dimensions in the virtual workspace including a plurality of digital assets; and
wherein the spatial event map allows for rendering, in the display space on the display of each of the client-side network nodes, a first curated set of digital assets of the plurality of digital assets that are included in the location and dimensions in the virtual workspace represented by the local client viewport, the digital assets of the first curated set including only digital assets identified as first priority digital assets and excluding other digital assets, of the plurality of digital assets, not identified as being first priority digital assets.
